(19) United States
(12) Patent Application Publication
(10) Pub. No.: US 2026/0024690 A1
(43) Pub. Date: Jan. 22, 2026

(54) CONTAINER FOR SUPERCONDUCTING WIRE CONNECTION AND SUPERCONDUCTING MAGNET

(71) Applicant: CANON MEDICAL SYSTEMS CORPORATION, Otawara-shi (JP)

(72) Inventors: Takehiro SHIBUYA, Nasushiobara Tochigi (JP); Michiru KAJIWARA, Nasushiobara Tochigi (JP); Hiromi KAWAMOTO, Yaita Tochigi (JP); Sadanori TOMIHA, Nasushiobara Tochigi (JP); Katsutoshi MIZUNO, Nasushiobara Tochigi (JP)

(73) Assignee: CANON MEDICAL SYSTEMS CORPORATION, Otawara-shi (JP)

(21) Appl. No.: 19/273,272

(22) Filed: Jul. 18, 2025

(30) Foreign Application Priority Data
Jul. 19, 2024 (JP) 2024-115554

(51) Int. Cl. H01F 6/06; H01B 12/02

(52) U.S. Cl. CPC H01F 6/06; H01B 12/02

(57) ABSTRACT

A container for superconducting wire connection according to an embodiment includes a superconducting wire material including a superconducting material, a superconducting substance, and a container. The superconducting substance is used to electrically bond two or more of the superconducting wire materials. The container includes an outer wall and a bottom plate. The outer wall holds the superconducting substance and the superconducting wire materials, the outer wall having a concave part and/or a convex part.

### CROSS-REFERENCE TO RELATED APPLICATIONS

This application is based upon and claims the benefit of priority from Japanese Patent Application No. 2024-115554, filed on Jul. 19, 2024; the entire contents of which are incorporated herein by reference.

### FIELD

Embodiments described herein relate generally to a container for superconducting wire connection and a superconducting magnet.

### BACKGROUND

Some magnetic resonance imaging (MRI) devices use superconducting magnets including superconductors. For forming the superconducting magnet, connection between superconducting wires is important. In connection between superconducting wires, it is important to suppress power loss.

Here, in one method for connecting superconducting wires, the superconducting wires are soldered together using a superconducting solder that exhibits superconductivity at low temperature, the superconducting wires after the soldering are sealed in a container to form a container for superconducting wire connection, and the superconducting wires are connected using the container.

However, when the container for superconducting wire connection is formed, filaments of superconducting materials may float and come into contact with air on the surface to oxidize, becoming an insulator. In this case, connection characteristic of superconducting wires will deteriorate.

### BRIEF DESCRIPTION OF THE DRAWINGS

FIG. 1 is a diagram describing one example of the procedure for forming a container for superconducting wire connection;

FIG. 2 is a diagram describing one example of the procedure for forming the container for superconducting wire connection;

FIG. 3 is a diagram describing an appearance of a container for superconducting wire connection according to a comparative example;

FIG. 4 is a cross-sectional view describing a configuration of the container for superconducting wire connection according to the comparative example;

FIG. 5 is a diagram describing an appearance of a container for superconducting wire connection according to the comparative example;

FIG. 6 is a cross-sectional view describing the configuration of the container for superconducting wire connection according to the comparative example;

FIG. 7 is a cross-sectional view describing an example of a configuration of a container for superconducting wire connection according to a first embodiment;

FIG. 8 is a cross-sectional view describing an example of the configuration of the container for superconducting wire connection according to the first embodiment;

FIG. 9 is a cross-sectional view describing another example of the configuration of the container for superconducting wire connection according to the first embodiment;

FIG. 10 is a cross-sectional view describing another example of the configuration of the container for superconducting wire connection according to the first embodiment;

FIG. 11 is a diagram describing another example of the configuration of the container for superconducting wire connection according to the first embodiment;

FIG. 12 is a cross-sectional view describing an example of a configuration of a container for superconducting wire connection according to a second embodiment;

FIG. 13 is a cross-sectional view describing another example of the configuration of the container for superconducting wire connection according to the second embodiment;

FIG. 14 is a cross-sectional view describing another example of the configuration of the container for superconducting wire connection according to the second embodiment;

FIG. 15 is a diagram describing another example of the configuration of the container for superconducting wire connection according to the second embodiment;

FIG. 16 is a cross-sectional view describing another example of the configuration of the container for superconducting wire connection according to the second embodiment;

FIG. 17 is a diagram describing another example of the configuration of the container for superconducting wire connection according to the second embodiment; and

FIG. 18 is a cross-sectional view describing another example of the configuration of the container for superconducting wire connection according to the second embodiment.

### DETAILED DESCRIPTION

A container for superconducting wire connection provided in an aspect of the present invention includes a superconducting wire material including a superconducting material, a superconducting substance, and a container. The superconducting substance is used to electrically bond two or more of the superconducting wire materials. The container includes an outer wall and a bottom plate. The outer wall holds the superconducting substance and the superconducting wire materials, the outer wall having a concave part and/or a convex part.

### First Embodiment

With reference to drawings, embodiments of a superconducting wire connection container and a superconducting magnet will be described below in detail.

First, the connection of superconducting wire materials is described. For example, superconducting magnets including superconductors are used in magnetic resonance imaging (MRI) devices, and connection between superconducting wires is important for forming superconducting magnets. In connection between superconducting wires, it is important to suppress power loss.

In one method for connecting between superconducting wires, the superconducting wires are soldered using a superconducting solder that exhibits superconductivity at low temperature, and the soldered superconducting wires are sealed in a container to form a container for superconducting wire connection. By the connection of the superconducting wires through this container for superconducting wire connection, for example, a superconducting magnet for MRI can be generated.

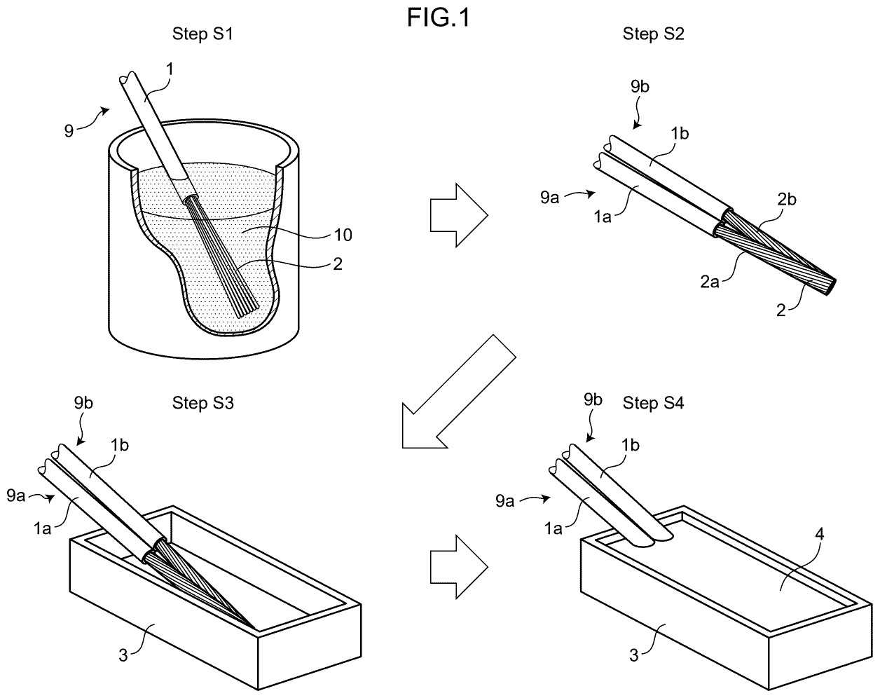

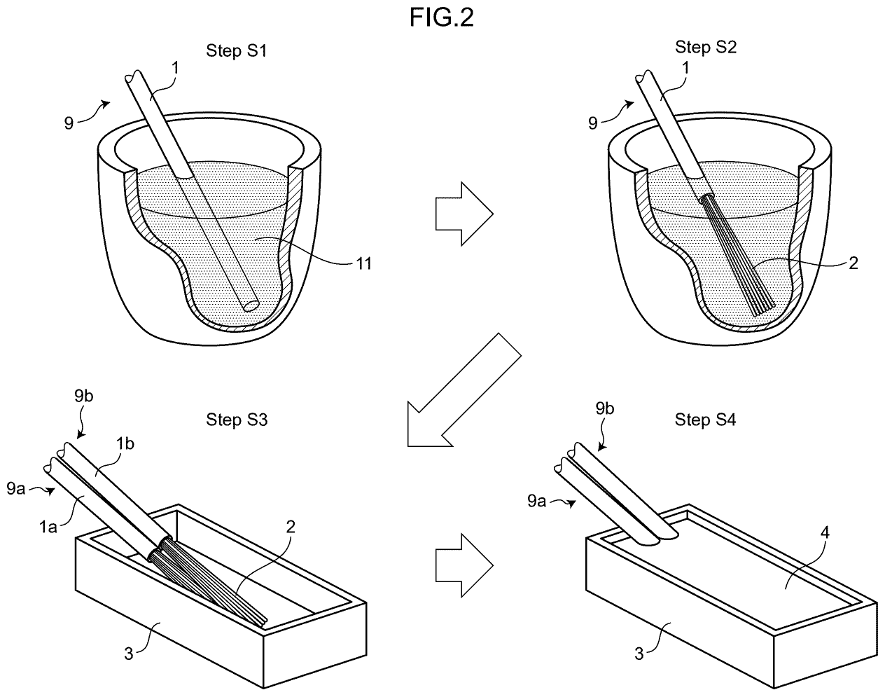

FIG. 1 and FIG. 2 illustrate examples of the procedure for forming the container for superconducting wire connection. FIG. 1 illustrates an example in a case of forming the container for superconducting wire connection by a method of soldering filaments of the superconducting wire materials after immersed in concentrated nitric acid, and FIG. 2 illustrates an example in a case of forming the container for superconducting wire connection by a method of soldering the superconducting wire materials after tin substitution.

FIG. 1 illustrates the example in the case in which the container for superconducting wire connection is formed by the method of soldering the filaments of the superconducting wire materials after immersed in concentrated nitric acid. First, at step S1, a superconducting wire material 9 typically includes a base material 1 containing copper or a copper compound, and a superconducting material 2 provided inside the base material 1. For example, NbTi, Nb₃Sn, or the like is used as the superconducting material 2. When the superconducting wire material 9 is immersed in concentrated nitric acid 10, the base material 1, which is formed of copper or the copper compound, dissolves, so that the superconducting material 2 therein is exposed and forms a filament shape.

Subsequently, at step S2, the two filaments in the parts of the superconducting materials 2 thus exposed in this way are twisted together. Specifically, a superconducting material 2a with a filament shape in a superconducting wire material 9a formed of a base material 1a and the superconducting material 2a, and a superconducting material 2b with a filament shape in a superconducting wire material 9b formed of a base material 1b and the superconducting material 2b are twisted together; thus, the superconducting wire material 9a and the superconducting wire material 9b are connected to each other.

Subsequently, at step S3, the superconducting wire material 9a and the superconducting wire material 9b are placed in a container 3. The container 3 is typically made of a conductive material such as copper.

Then, at step S4, two or more superconducting wire materials, that is, the superconducting wire material 9a and the superconducting wire material 9b are electrically bonded to each other by a superconducting substance 4. The superconducting substance 4 is, for example, a solder that exhibits superconductivity at low temperature. In one example, the superconducting wire material 9a and the superconducting wire material 9b are soldered together by the solder as the superconducting substance 4, which is in a liquid state at high temperature (exhibiting a superconducting state at low temperature), and the superconducting substance 4 solidifies at low temperature. Thus, the superconducting wire material 9a and the superconducting wire material 9b are electrically bonded to each other by the superconducting substance 4. In the low-temperature state after further cooling to, for example, liquid helium temperature, the superconducting substance 4 becomes the superconducting state, so that the electrical resistance of a connection part between the superconducting wire material 9a and the superconducting wire material 9b becomes zero and power loss is suppressed.

FIG. 2 illustrates an example in a case of forming the container for superconducting wire connection by the method of soldering the filaments of the superconducting wire materials 9 after the tin substitution. First, at step S1, the superconducting wire material 9 typically includes the base material 1 containing copper or the copper compound, and the superconducting material provided inside the base material 1. For example, NbTi, Nb₃Sn, or the like is used as the superconducting material. When the superconducting wire material 9 is immersed into molten tin 11, the base material 1 formed of copper or the copper compound dissolves and the superconducting material 2 is exposed, as can be seen at step S2. At this time, a surface of the superconducting material 2 is coated with tin. Accordingly, tin plating is performed. Such an operation is performed for each of the two superconducting wire materials.

Subsequently, at step S3, the tin-plated superconducting wire materials 9a and 9b are placed in the container 3. The container 3 is typically made of a conductive material such as copper.

Then, at step S4, two or more superconducting wire materials, that is, the superconducting wire material 9a and the superconducting wire material 9b are electrically bonded to each other by a superconducting substance 4. Specifically, the superconducting substance 4 is a solder that exhibits superconductivity at low temperature, for example. In one example, the superconducting wire material 9a and the superconducting wire material 9b are soldered together by the solder as the superconducting substance 4, which is in a liquid state at high temperature (exhibiting a superconducting state at low temperature), and the superconducting substance 4 solidifies at low temperature. Thus, the superconducting wire material 9a and the superconducting wire material 9b are electrically bonded to each other by the superconducting substance 4. In the low-temperature state after further cooling to, for example, liquid helium temperature, the superconducting substance 4 becomes the superconducting state, so that the electrical resistance of a connection part between the superconducting wire material 9a and the superconducting wire material 9b becomes zero and power loss is suppressed.

In the aforementioned method for forming the container for superconducting wire connection for the connection of the superconducting wires, the container for superconducting wire connection is formed by the method of soldering the filaments after the immersion in the concentrated nitric acid or the container for superconducting wire connection is formed by the method of soldering the superconducting wire materials after the tin substitution. However, the embodiment is not limited to this example, and in the embodiment, the superconducting wires may be connected by crimp bonding, solid-phase bonding, or the like.

Here, the crimp bonding means a method of bonding a plurality of superconducting wire materials by crimping. In the case of the crimp bonding, first, steps S1 and S2 in FIG. 1 are performed similarly. In the case of the crimp bonding, the superconducting wire material 9a and the superconducting wire material 9b are inserted into a metal sleeve at step S3. At step S4, the superconducting wire material 9a and the superconducting wire material 9b are bonded together by crimping with pressure applied by the metal sleeve. Finally, the vicinity of an entrance of the metal sleeve is soldered.

In the case of the solid-phase bonding, steps S1 and S2 in FIG. 1 are performed similarly. In the case of the solid-phase bonding, the superconducting wire material 9a and the superconducting wire material 9b are inserted into a compression jig at step S3. At step S4, the compression jig is pressurized and heated to perform the solid-phase bonding of the superconducting wire material 9a and the superconducting wire material 9b.

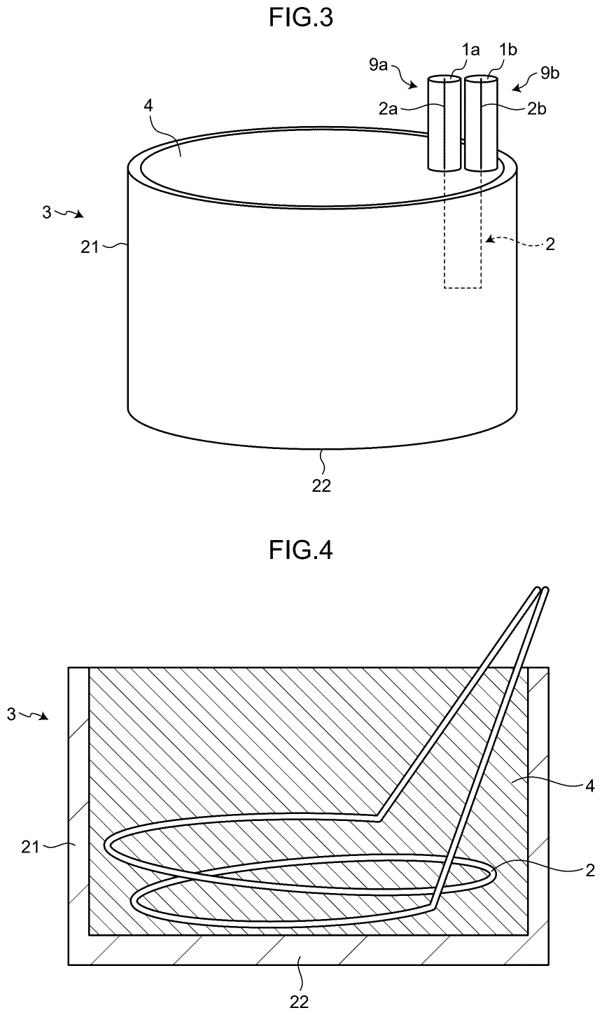

The configuration of the container for superconducting wire connection will be described more specifically with reference to FIG. 3 and FIG. 4. FIG. 3 is an external view of a container for superconducting wire connection according to a comparative example, and FIG. 4 is a cross-sectional view of the container for superconducting wire connection according to the comparative example.

As illustrated in FIG. 3 and FIG. 4, the container for superconducting wire connection according to the comparative example includes the superconducting wire materials 9a and 9b including the superconducting materials 2a and 2b, the superconducting substance 4 used to electrically bond two or more of the superconducting wire materials 9a and 9b, and the container 3 including an outer wall 21 and a bottom plate 22 to hold the superconducting substance 4 and the superconducting wire materials 9a and 9b. Here, the superconducting wire materials 9a and 9b include the base materials 1a and 1b containing copper or the copper compound, and the superconducting materials 2a and 2b provided inside the base materials 1a and 1b. The superconducting substance 4 is, for example, a solder that exhibits superconductivity at low temperature. The superconducting wire materials included in the superconducting coil of the superconducting magnet, for example, are connected to each other using the container for superconducting wire connection according to the embodiment.

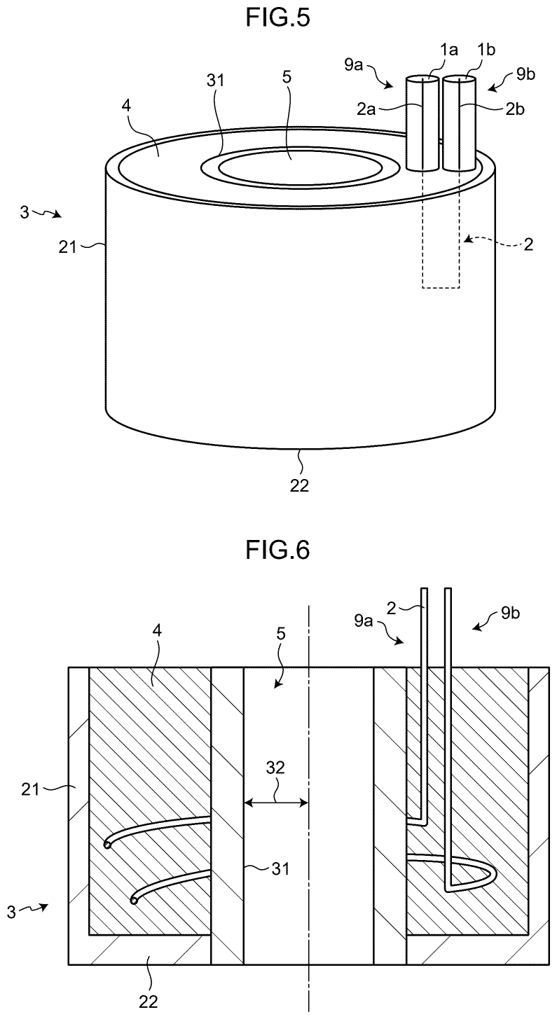

In addition, in order to control void formation at solidifying and cooling of the solder and to improve the cooling efficiency of the container, the container 3 may include a cavity 5 as illustrated in FIG. 5 and FIG. 6. FIG. 5 is an external view of the container for superconducting wire connection according to the comparative example in the case where the container 3 includes the cavity 5, and FIG. 6 is a cross-sectional view of the container for superconducting wire connection according to the comparative example in the case where the container 3 includes the cavity 5.

As illustrated in FIG. 5 and FIG. 6, the container for superconducting wire connection according to the comparative example includes the superconducting wire materials 9a and 9b including the superconducting materials 2a and 2b, the superconducting substance 4 used to electrically bond two or more of the superconducting wire materials 9a and 9b, and the container 3 including the outer wall 21 and the bottom plate 22 to hold the superconducting substance 4 and the superconducting wire materials 9a and 9b. Here, similarly to the case in FIG. 3 and FIG. 4, the superconducting wire materials 9a and 9b include the base materials 1a and 1b containing copper or the copper compound, and the superconducting materials 2a and 2b provided inside the base materials 1a and 1b. The superconducting substance 4 is, for example, a solder that exhibits superconductivity at low temperature.

Here, the cavity 5 is provided from the bottom plate part of the container 3. The container 3 includes an inner wall 31 that is at least partially integrated with the bottom plate 22. The inner wall 31 may be formed of a conductive material to enhance thermal conductivity.

Here, the cavity 5 is provided from the bottom plate part of the container 3, so that a difference is produced in cooling rate between the inner wall 31 and the outer wall 21; thus, the void generation can be controlled. In addition, the provision of the cavity makes it possible to efficiently cool the container 3 when, for example, the container is incorporated and operated as a part of a superconducting magnet.

Subsequently, the background related to the embodiment will be described.

When the container for superconducting wire connection is formed, the container 3 is filled with the superconducting solder, which becomes the superconductor at low temperature, as the superconducting substance 4. Before being cooled and solidified, the superconducting substance 4 is in a liquid metal state. Thus, the filament of the superconducting material 2 may float and come into contact with air on the surface of the superconducting substance 4 to oxidize, becoming an insulator. If the filament of the superconducting material 2 oxidizes due to contact with air and becomes the insulator, electrical resistance is generated and the connection characteristic of the superconducting wire deteriorates.

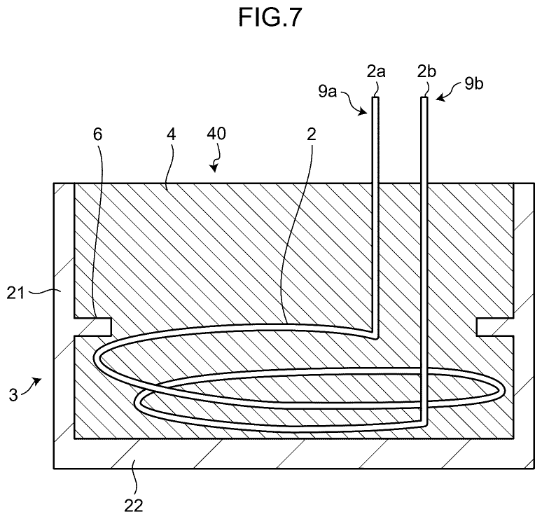

In view of this background, for example, the container for superconducting wire connection according to the embodiment includes the superconducting wire materials 9a and 9b including the superconducting material 2, the superconducting substance 4 used to electrically bond two or more of the superconducting wire materials 9a and 9b, and the container 3 including the outer wall 21 and the bottom plate 22 to hold the superconducting substance 4 and the superconducting wire materials 9a and 9b, the outer wall 21 having a concave part and/or convex part 6, as illustrated in FIG. 7.

Here, FIG. 7 illustrates the case where the concave part and/or convex part 6 is a convex part. In this case, by the existence of the concave part and/or convex part 6 at the outer wall 21, a filament part of the superconducting material 2 is caught by the concave part and/or convex part 6 by mechanical contact. This can prevent the superconducting material 2 from floating on a surface 40 and oxidizing due to reaction with atmospheric oxygen. Thus, the deterioration of the connection characteristic of the superconducting wire can be avoided. In other words, when the two or more of the superconducting materials 2a and 2b are electrically bonded to each other using the superconducting substance 4, the concave part and/or convex part 6 mechanically presses the superconducting material 2, thereby preventing the superconducting material 2 from floating in the container 3.

In addition to this, the concave part and/or convex part 6 protrudes at the outer wall 21, which can increase the cooling efficiency of the container 3.

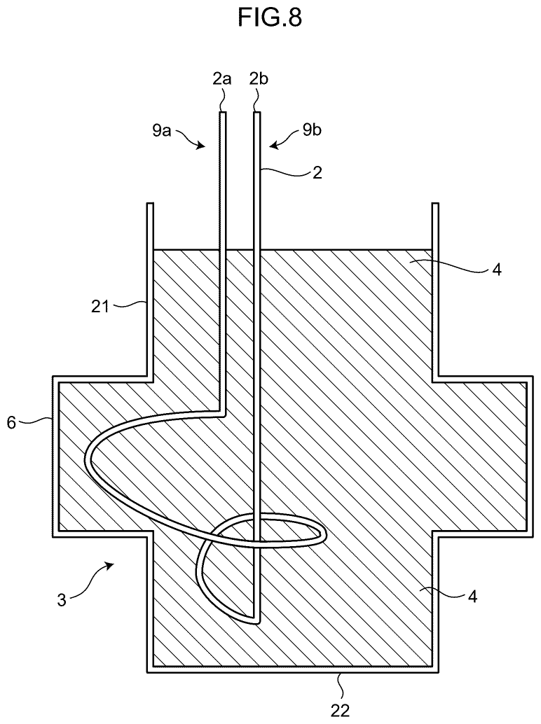

Note that the concave part and/or convex part 6 in the embodiment may be formed by a concave part as illustrated in FIG. 8. In this case, the superconducting wire materials 9a and 9b including the superconducting material 2, the superconducting substance 4 used to electrically bond two or more of the superconducting wire materials 9a and 9b, and the container 3 including the outer wall 21 and the bottom plate 22 to hold the superconducting substance 4 and the superconducting wire materials 9a and 9b, the outer wall 21 having the concave part and/or convex part 6 are provided.

Here, in FIG. 8, the concave part and/or convex part 6 is a concave part, and the filament part of the superconducting material 2 is caught by a dent part of the concave part and/or convex part 6 by mechanical contact. This can prevent the superconducting material 2 from floating on the surface and oxidizing due to reaction with atmospheric oxygen. Thus, the deterioration of the connection characteristic of the superconducting wire can be avoided.

In addition to this, the concave part and/or convex part 6 has a larger contact area with the superconducting substance 4, which can increase the cooling efficiency of the container 3.

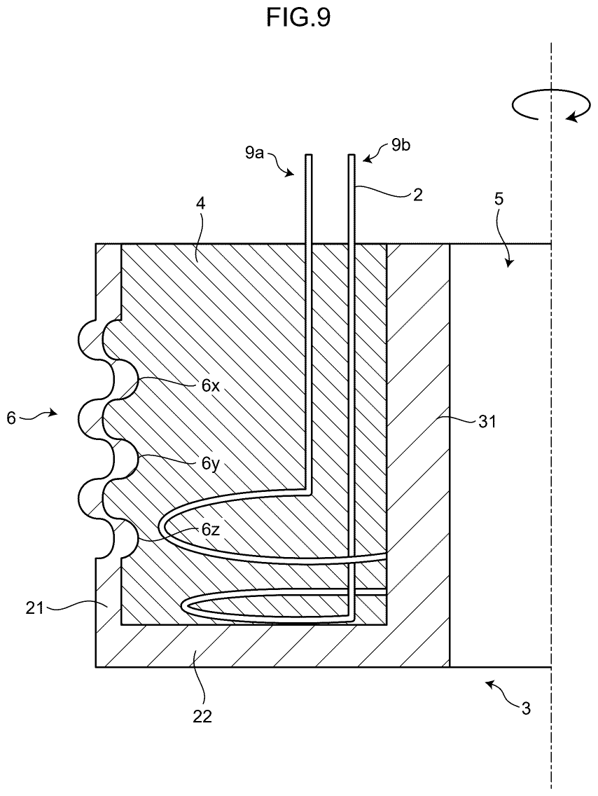

FIG. 9 illustrates another example of the concave part and/or convex part 6. FIG. 9 describes an example where the container 3 has a configuration similar to that in FIG. 6, and the container 3 includes the outer wall 21, the bottom plate 22, and the inner wall 31. The container 3 has a roughly symmetrical shape around the central axis and has a cavity 5 inside. The structure of a portion of such container 3 is shown in FIG. 9. The superconducting material 2 is wound, for example, along the inner wall or outer wall of the container 3. Here, the concave part and/or convex part 6 at the outer wall 21 has a bellows structure and has a shape including a plurality of arcs 6x, 6y, and 6z. The concave part and/or convex part 6 prevents the superconducting material 2 from floating in the container 3 by the mechanical contact with the superconducting material 2, and by keeping the surface area in contact with the superconducting substance 4 large, the container 3 can be cooled efficiently.

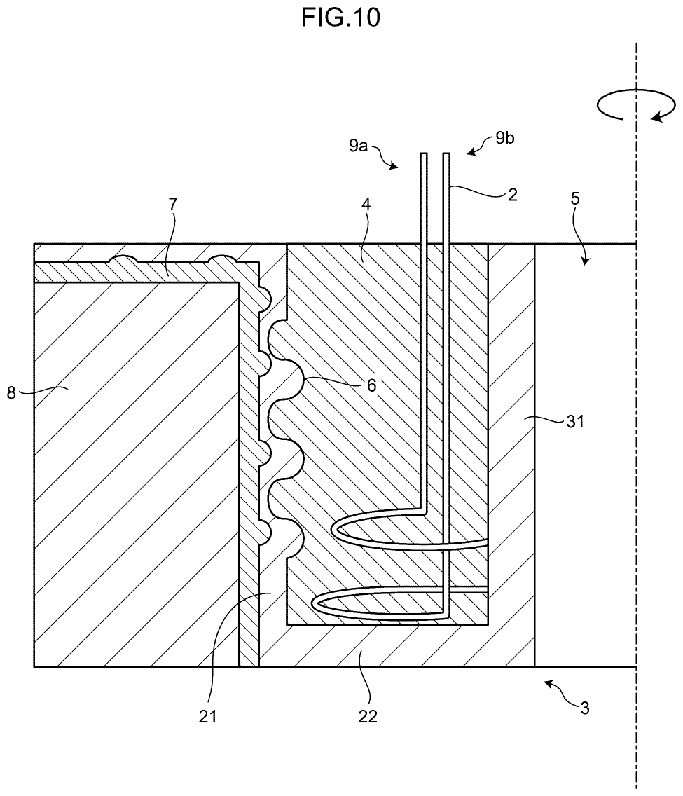

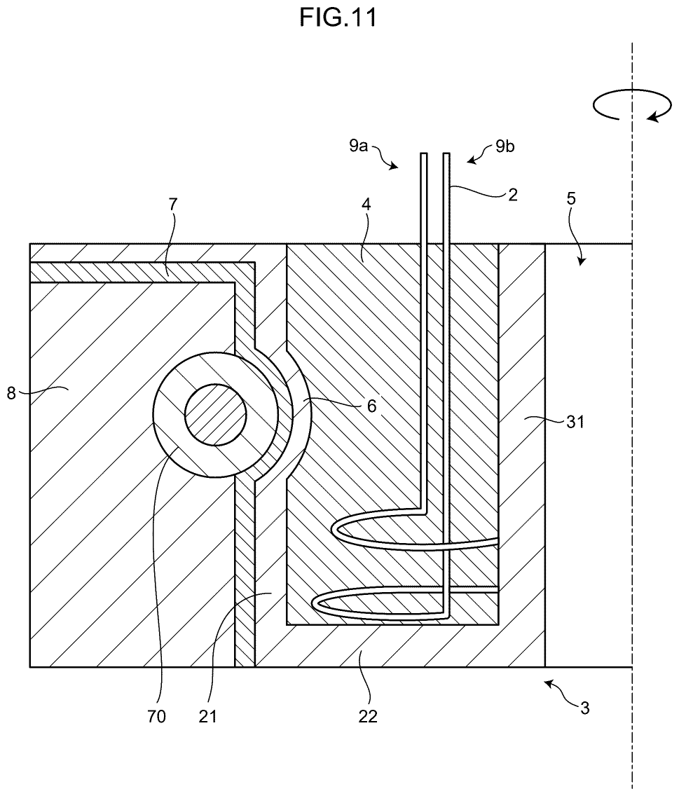

As another example, a cooling unit that cools the container 3 through the outer wall 21 may be provided to the concave part and/or convex part 6. FIG. 10 illustrates one example of such a configuration. In FIG. 10, the outer wall 21 of the container 3 includes the concave part and/or convex part 6 with a bellows structure, while the container 3 includes an adhesive layer 7 in contact with the outer wall 21 having the concave part and/or convex part 6 and a metal member 8 in contact with the adhesive layer 7. Here, the cooling unit includes the adhesive layer 7 in contact with the outer wall 21 including the concave part and/or convex part 6, and the metal member 8 in contact with the adhesive layer 7. In order for the concave part and/or convex part 6 to obtain the shape that suits a member to cool, the concave part and/or convex part 6 has a shape that increases the contact area with the superconducting substance 4 and the cooling unit. For the adhesive layer 7, metals such as indium, aluminum, solder, alloys used for welding rods, and resins such as epoxy and silicone are selected.

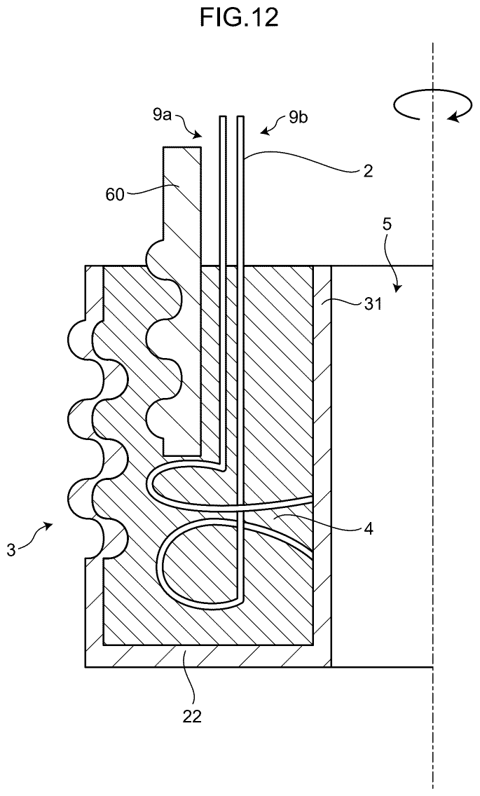

As another example of the cooling unit, the cooling unit may be a heat transfer body for cooling by a thermosiphon or a heat pipe system. The use of a heat transfer body for cooling by a thermosiphon or a heat pipe system can further improve the cooling efficiency of the container 3. FIG. 11 illustrates such an example.

In FIG. 11, the adhesive layer 7 is in contact with the concave part and/or convex part 6 of the outer wall 21, and a thermosiphon, which is a cooling member 70, is disposed in contact with the adhesive layer 7 and the metal member 8. The concave part and/or convex part 6 forms a gentle arcs, preventing the superconducting material 2 from floating in the container 3 and allowing rapid cooling of the superconducting substance 4 in contact with the concave part and/or convex part 6 through the thermosiphon, which is the cooling member 70.

The embodiment is not limited to the above examples. In the aforementioned example, the concave part and/or convex part 6 is provided at the outer wall 21; however, the location where the concave part and/or convex part 6 is provided is not limited to this example. For example, the concave part and/or convex part 6 may be provided at the inner wall 31 or the bottom plate 22. The concave part and/or convex part 6 may be provided at two or more locations among the outer wall 21, the inner wall 31, and the bottom plate 22.

The shape of the concave part and/or convex part 6 is not limited to the examples given above and may be a circle, an ellipse, a quadrangle, a polygon, or various other shapes. The concave part and/or convex part 6 may be cone-shaped (conical), for example. In this case, when the superconducting material 2 is input into the container 3, the superconducting material 2 is less likely to be caught.

The concave part and/or convex part 6 is not limited to a symmetrical arrangement and may alternatively be arranged asymmetrically. The concave part and/or convex part 6 may have different shapes depending on locations, and may have different diameter lengths, side lengths, areas, and the like.

The material of the cooling unit is not limited to the above example, and the cooling unit may be formed of, for example, copper, aluminum, SUS, ceramic, resin, polyimide, a plastic material, or a refrigerant.

As described above, in the first embodiment, the outer wall 21 of the container 3 includes the concave part and/or convex part 6. Thus, the concave part and/or convex part 6 comes into mechanically contact with the filament part of the superconducting material 2, thereby preventing the superconducting material 2 from floating and oxidizing due to the contact with the atmosphere, and moreover, the concave part and/or convex part 6 keeps the contact area with the superconducting substance 4 and the cooling unit large, thereby contributing to efficient cooling of the container 3.

### Second Embodiment

The embodiment is not limited to the above embodiment. As one example, the concave part and/or convex part 6 may be a rod-shaped member. For example, as illustrated in FIG. 12, in the second embodiment, a rod-shaped member 60 becomes the concave part and/or convex part 6, which acts like a drop lid, and mechanically contacts with the filament part of the superconducting material 2, thereby preventing the superconducting material 2 from floating. Moreover, the rod-shaped member 60 keeps the contact area with the superconducting substance 4 large, thereby contributing to efficient cooling of the container 3.

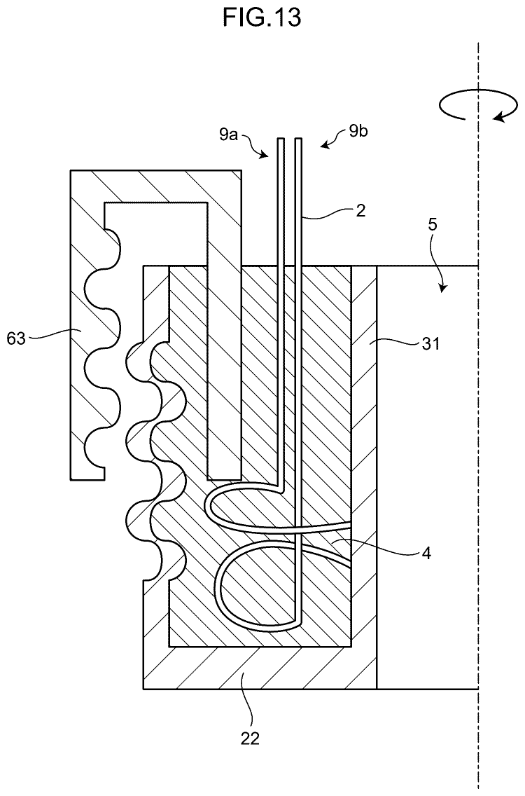

The shape of the rod-shaped member is not limited to the above example, and in another example, the concave part and/or convex part 6 may be a rod-shaped member 63 with a U shape as illustrated in FIG. 13. The rod-shaped member 63 with the U shape is placed in the container 3 in such a way that the rod-shaped member 63 is hooked on the container 3, thereby preventing the superconducting material 2 from floating.

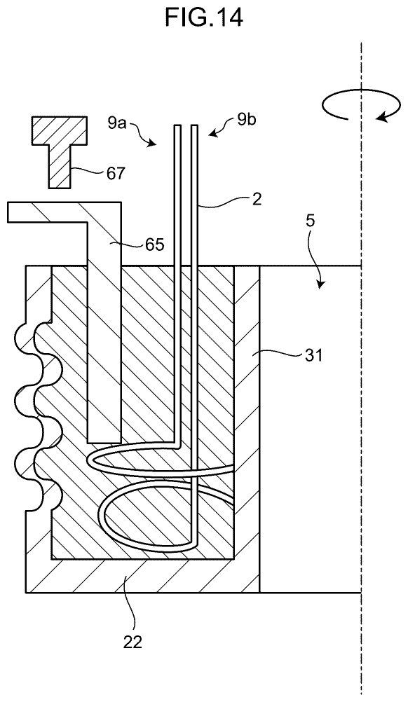

In addition, a fixing unit to fix the rod-shaped member may be further provided. Examples of the fixing unit include mechanical fixing with bolting. In one example, as illustrated in FIG. 14, a bolt 67 may be provided as the fixing unit to fix a rod-shaped member 65 as the concave part and/or convex part 6.

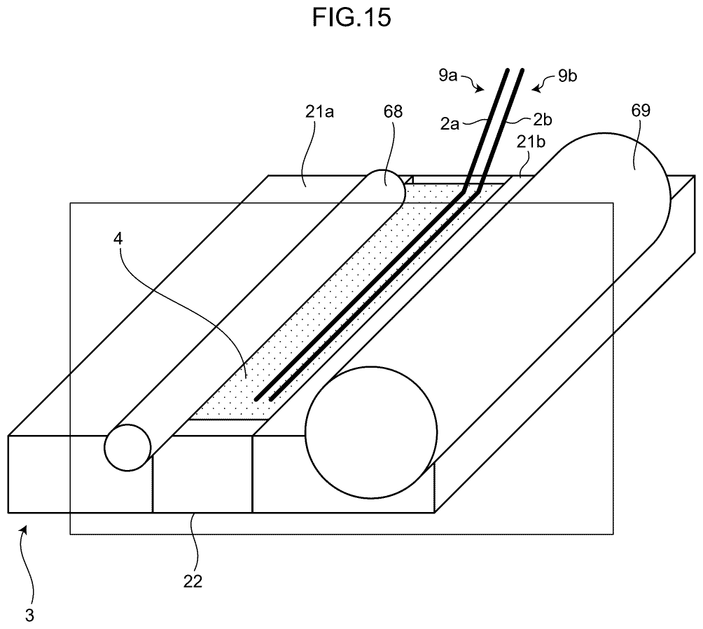

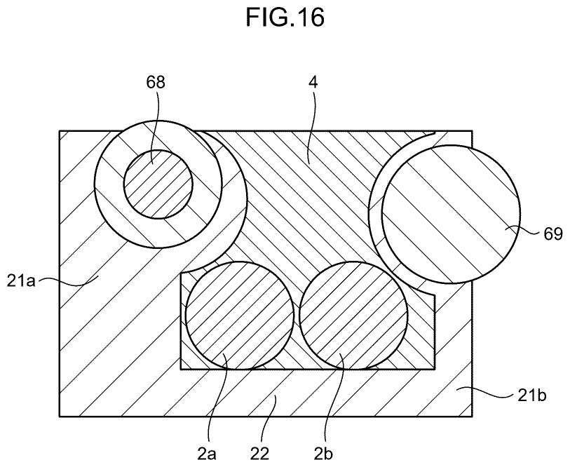

In the embodiment described above, the container 3 is a cylindrical container; however, the embodiment is not limited to this example. In other words, the container 3 may be a rectangular container. FIG. 15 and FIG. 16 illustrate examples of such an embodiment. FIG. 15 is an external view of the container for superconducting wire connection when the container 3 is a rectangular container, and FIG. 16 is a cross-sectional view.

As illustrated in FIG. 15 and FIG. 16, the container for superconducting wire connection according to the embodiment includes the superconducting wire materials 9a and 9b including the superconducting materials 2a and 2b, the superconducting substance 4 used to electrically bond two or more of the superconducting wire materials 9a and 9b, and the container 3 including outer walls 21a and 21b and the bottom plate 22 to hold the superconducting substance 4 and the superconducting wire materials 9a and 9b. Here, in FIG. 15, the outer wall 21a includes a convex part 68 and the outer wall 21b includes a convex part 69. The convex part 68 includes a thermosiphon, for example, and the convex part 69 will serve as the cooling unit formed of copper, aluminum, SUS, ceramic, resin, polyimide, a plastic material, a refrigerant, or the like.

At this time, the convex part 68 and the convex part 69 come into mechanically contact with the filament part of the superconducting materials 2a and 2b, thereby preventing the superconducting materials 2a and 2b from floating and oxidizing due to the contact with the atmosphere, and moreover, the convex part 68 and the convex part 69 keep the contact area with the superconducting substance 4 and the cooling unit large, thereby contributing to efficient cooling of the container 3. Thus, even when the container 3 is a rectangular container, devising the shape of the convex part makes it possible to suppress the floating of the wire material and secure the contact area between the convex part and the external cooling member.

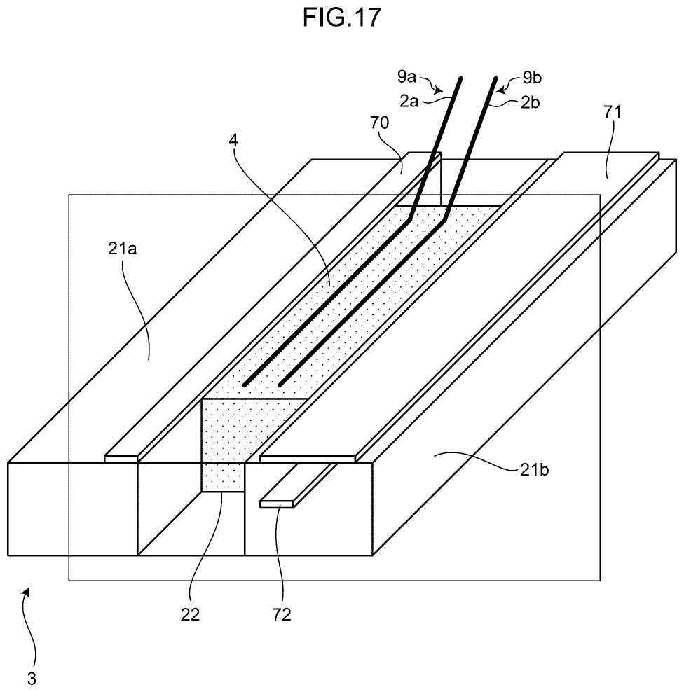

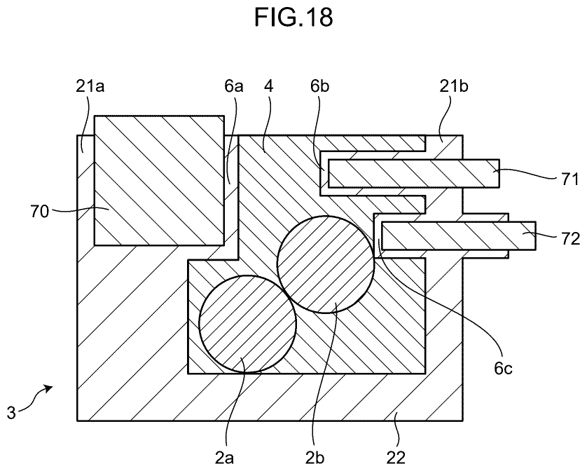

FIG. 17 and FIG. 18 illustrate another example of the embodiment. The connection method for the superconducting wire materials is not limited to the solder connection, and in other examples, the superconducting wire materials may be connected to each other by solid-phase bonding or crimp bonding. FIG. 17 and FIG. 18 illustrate such an example. FIG. 17 is an external view, and FIG. 18 is a cross-sectional view.

As illustrated in FIG. 17 and FIG. 18, the container for superconducting wire connection according to the embodiment includes the superconducting wire materials 9a and 9b including the superconducting materials 2a and 2b, the superconducting substance 4 used to electrically bond two or more of the superconducting wire materials 9a and 9b, and the container 3 including outer walls 21a and 21b and the bottom plate 22 to hold the superconducting substance 4 and the superconducting wire materials 9a and 9b. Here, as illustrated in FIG. 17, a convex part 6a of the outer wall 21a includes the cooling member 70, a convex part 6b of the outer wall 21b includes a cooling member 71, and a convex part 6c of the outer wall 21b includes a cooling member 72. In addition to the shapes illustrated in the drawings, the cooling members 70, 71 and 72 may have various shapes such as a circle, an ellipse, a quadrangle, and a polygon, and a plurality of the convex parts 6b and 6c may be arranged to suppress the floating of the superconducting materials 2a and 2b.

At this time, the convex part 6a of the outer wall 21a and the convex parts 6b and 6c of the outer wall 21b come into mechanically contact with the filament part of the superconducting materials 2a and 2b, thereby preventing the superconducting materials 2a and 2b from floating and oxidizing due to the contact with the atmosphere, and moreover, the respective convex parts 6a, 6b, and 6c keep the contact area with the cooling members 70, 71, and 72 large, thereby contributing to efficient cooling of the container 3.

According to at least one of the embodiments described above, when the container for superconducting wire connection is formed, the floating of the filament of the superconducting material can be prevented and the cooling effect of the container can be enhanced.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A container for superconducting wire connection comprising:
a superconducting wire material including a superconducting material;
a superconducting substance used to electrically bond two or more of the superconducting wire materials; and
a container including an outer wall and a bottom plate, the outer wall holding the superconducting substance and the superconducting wire materials, the outer wall having a concave part and/or a convex part.

2. The container for superconducting wire connection according to claim 1, wherein when the two or more of the superconducting wire materials are electrically bonded to each other using the superconducting substance, the concave part and/or the convex part mechanically presses the superconducting wire materials to prevent the superconducting wire materials from floating in the container.

3. The container for superconducting wire connection according to claim 1, wherein a cooling unit that cools the container through the outer wall is provided to the concave part and/or the convex part.

4. The container for superconducting wire connection according to claim 3, wherein the cooling unit is a heat transfer body for cooling by a thermosiphon or a heat pipe system.

5. The container for superconducting wire connection according to claim 3, wherein the cooling unit includes an adhesive layer in contact with the outer wall and a metal member in contact with the adhesive layer.

6. The container for superconducting wire connection according to claim 5, wherein the adhesive layer is metal or resin.

7. The container for superconducting wire connection according to claim 3, wherein the convex part has a shape whose contact area with the cooling unit is large.

8. The container for superconducting wire connection according to claim 3, wherein the cooling unit is formed of copper, aluminum, SUS, ceramic, resin, polyimide, a plastic material, or a refrigerant.

9. The container for superconducting wire connection according to claim 1, wherein the convex part is a rod-shaped member.

10. The container for superconducting wire connection according to claim 9, further comprising a fixing unit that fixes the member.

11. The container for superconducting wire connection according to claim 1, wherein the concave part and/or the convex part has a bellows structure.

12. The container for superconducting wire connection according to claim 1, wherein the concave part and/or the convex part has a shape including an arc.

13. The container for superconducting wire connection according to claim 1, wherein the container is a rectangular container.

14. The container for superconducting wire connection according to claim 1, wherein
the superconducting wire material includes a base material containing copper or a copper compound, and the superconducting material provided inside the base material, and
the superconducting substance is a solder that exhibits superconductivity at low temperature.

15. A superconducting magnet wherein a superconducting wire material included in a superconducting coil is connected using the container for superconducting wire connection according to claim 1.
